(19) United States
(12) Patent Application Publication
(10) Pub. No.: US 2021/0230865 A1
(43) Pub. Date: Jul. 29, 2021

(54) DOUBLE FACED MEDIUM DENSITY POLYISO BOARD

(71) Applicant: JOHNS MANVILLE, Denver, CO (US)

(72) Inventors: Diana Fisler, Centennial, CO (US); Ralph Michael Fay, Lakewood, CO (US); Stanislav Kukatin, Centennial, CO (US)

(21) Appl. No.: 16/773,747

(22) Filed: Jan. 27, 2020

(51) Int. Cl. E04B 1/94; E04C 2/20; E04B 1/80; B32B 5/02; B32B 5/18; B32B 5/24

(52) U.S. Cl. CPC E04B 1/947; E04C 2/205; E04B 1/80; B32B 5/022; B32B 5/18; B32B 2419/00; E04B 2103/04; B32B 2255/02; B32B 2262/101; B32B 2266/0278; B32B 2307/304; B32B 5/245

(57) ABSTRACT

A polyiso foam wall board includes a polyisocyanurate foam core produced from an isocyanate and a polyol. The wall board also includes a facer material applied to an outer surface of the polyisocyanurate foam core and an intumescent coating applied to the facer material.

### BACKGROUND OF THE INVENTION

Wall structures in both commercial and residential buildings typically use gypsum drywall sheets as an interior building sheathing. However, in some applications, the use of gypsum drywall has drawbacks. For example, the sheets can be quite heavy, which makes its use difficult in interiors of recreational vehicles (RVS), tiny homes, manufactured homes, and the like in which reduced weight it an important consideration. Additionally, due to the brittle nature, gypsum drywall sheets do not allow for the use of crown staples in installation of the drywall, as such fasteners cause the gypsum drywall sheets to crack and/or otherwise breakdown.

### BRIEF SUMMARY OF THE INVENTION

Embodiments of the present invention are directed to polyiso foam boards that provide lightweight alternatives to using conventional gypsum drywall sheets in walling applications. The polyiso foam boards of the present disclosure are coated on at least one side with an intumescent substance that allows the polyiso foam boards to pass the NFPA 286 corner room burn test and the E84 tunnel burn test.

In one embodiment, a polyiso foam wall board is provided. The wall board may include a polyisocyanurate foam core produced from an isocyanate; and a polyol. The wall board may also include a facer material applied to an outer surface of the polyisocyanurate foam core and an intumescent coating applied to the facer material. In some embodiments, the intumescent coating includes ammonium polyphosphate, titanium dioxide, a melamine, pentaerythritol, kaolin, a polyamine polymer, tetraethylene pentamine, and/or aluminum trihydroxide. In some embodiments, the intumescent material includes at least about 30% limestone by weight of intumescent ingredients of the intumescent coating, less than about 8% perlite by weight, and less than about 8% talc by weight. In some embodiments, the intumescent material further includes less than about 8% attapulgite by weight and less than about 8% mica by weight. In some embodiments, the intumescent coating is applied with a coating weight of between about 5 and 50 g/sf. In some embodiments, the facer is a nonwoven glass mat facer. In some embodiments, the polyiso foam wall board includes at least one tapered edge.

In another embodiment, an interior wall structure is provided. The wall structure may include at least two walls studs spaced apart from one another to form a wall cavity and a wall board fastened to the at least two walls studs and covering at least a portion of the wall cavity. The wall board may include a polyisocyanurate foam core produced from an isocyanate and a polyol. The wall board may also include a facer material applied to an outer surface of the polyisocyanurate foam core and an intumescent coating applied to the facer material. In some embodiments, the wall board may be fastened to the at least two wall studs using crown staples. In some embodiments, the wall board may be fastened to the at least two wall studs using an adhesive. In some embodiments, the polyisocyanurate core may have an insulative R-value between about 4 and 7 per inch at 40° F. and/or the polyisocyanurate core may have an isocyanate index greater than or equal to 250. In some embodiments, the polyisocyanurate foam core may have an average foam cell size of less than 200 microns. In some embodiments, a density of the polyisocyanurate foam core is between about 1 and 10 lbs/ft³.

In another embodiment, a method of installing a polyiso foam board is provided. The method may include positioning a polyiso foam wall board against at least two wall studs to cover at least a portion of a wall cavity formed therebetween. The polyiso foam board may include a polyisocyanurate foam core produced from an isocyanate and a polyol. The foam board may also include a facer material applied to an outer surface of the polyisocyanurate foam core and an intumescent coating applied to the facer material. In some embodiments, a portion of the polyisocyanurate foam core may penetrate fibers of the facer material. The method may further include fastening the polyiso foam wall board to the at least two wall studs. In some embodiments, fastening the polyiso foam wall board to the at least two wall studs may include using a pneumatic device to insert crown staples through the polyiso foam wall board and into the at least two wall studs. In some embodiments, fastening the polyiso foam wall board to the at least two wall studs may include applying an adhesive to an interface between the polyiso foam board and the at least two wall studs. In some embodiments, the intumescent coating may be applied to the facer material after the polyiso foam wall board has been fastened to the at least two wall studs. In some embodiments, the intumescent coating may be applied to the facer material by one or both of spraying or painting.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a set of parentheses containing a second label that distinguishes among the similar components. If only the first reference label is used in the specification, the description is applicable to any one of the similar components having the same first reference label irrespective of the second reference label.

FIG. 1 depicts an embodiment of a PIR foam insulation board according to embodiments.

FIG. 2 depicts an embodiment of a PIR foam insulation board according to embodiments.

FIG. 3 is a flowchart depicting a process for forming a PIR foam according to embodiments.

FIG. 4 is a flowchart showing a portion of the process for forming a PIR foam board according to embodiments.

FIG. 5 is a flowchart depicting a process for forming a PIR foam board according to embodiments.

FIG. 6 illustrates a PIR foam board having tapered edges according to embodiments.

FIG. 7 illustrates a PIR foam board installed in a wall application according to embodiments.

FIG. 8 is a flowchart illustrating a process for installing a PIR foam board in a wall application according to embodiments.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to faced medium density polyiso foam boards that may be used as interior wall and/or ceiling building sheathing. The use of the wall boards of the present invention in wall applications provides numerous benefits over traditional interior wall sheathing. In particular, the wall boards of the present disclosure provide significantly lighter (approximately 16 lbs for a 4×8 ft board at % inch thick) alternatives to traditional gypsum drywall sheets (between approximately 44 and 47 lbs per 4×8 ft at % inch thick) in interior wall applications. In some embodiments, the reduced weight of the wall boards allows the boards to be secured to wall structures using an adhesive, which may eliminate the need to patch fastener locations. Additionally, the wall boards of the present invention provide greater thermal insulation than traditional gypsum walls boards and may eliminate and/or reduce the need to add additional insulation when used on interior surfaces of exterior walls. The walls boards of the present disclosure may be fastened using crown stables, which may increase the speed of installation. The wall boards are waterproof and mod resistant, making them ideal for flood prone areas and/or areas of exceptionally high humidity. Additionally, such wall boards may be easily scored and snapped, which makes them highly suitable for walling and ceiling applications.

The wall boards of the present invention include faced medium density polyiso foam boards in which the facer is coated with an intumescent material. The addition of intumescent material allows the wall boards to provide fire resistant properties. For example, the intumescent material may be applied such that the wall boards pass the NFPA 286 corner room burn test and the E84 tunnel burn test. The intumescent material may be applied in a factory setting and/or applied at the construction site during the construction of the wall and/or ceiling of a structure. The foam wall boards of the present invention may no or trace amounts of volatile organic compounds (VOC) and satisfy requirements for Greenguard Gold Level.

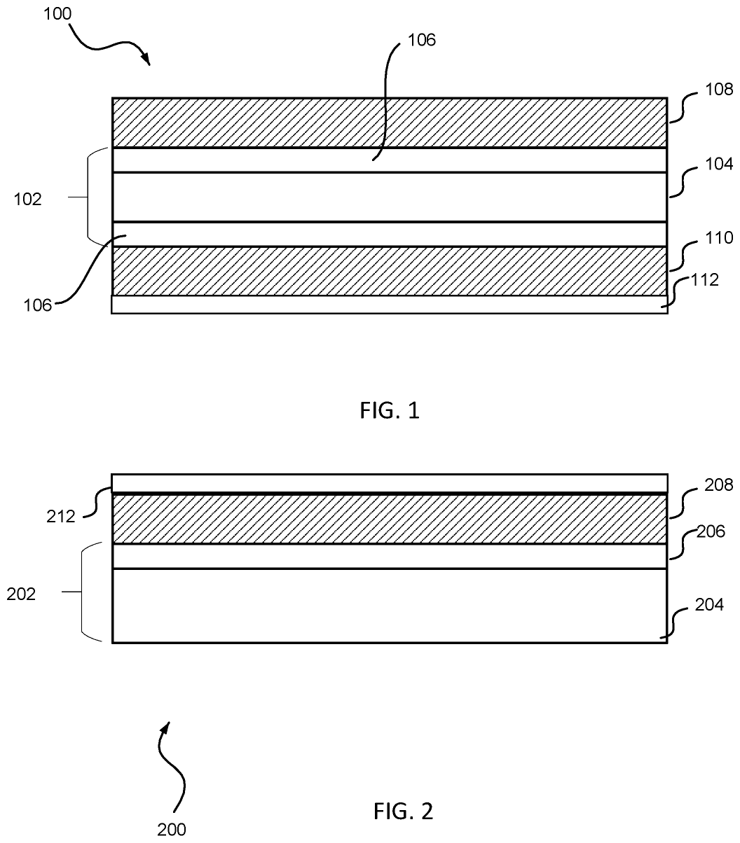

Turning now to FIG. 1, an embodiment of a polyiso foam board 100 is shown. The foam board 100 may include a polyisocyanurate foam core 102. The polyisocyanurate foam core 102 may have a medial portion 104 and opposing outer surfaces or outer portions 106. The polyisocyanurate foam core 102 is coupled with a first facer material 108 adjacent one of the outer portions 106 and coupled with a second facer material 110 adjacent the other outer portion 106. A density of the polyisocyanurate foam core 102 may be between about 1.50 and 2.0 lb/ft³.

The polyisocyanurate core 102 typically has an average foam cell size of less than about 200 microns, and more commonly between about 100-150. The polyisocyanurate foam core 102 may be formed from a mixture of an isocyanate and a polyol. For example, polyfunctional isocyanates that may form substituted or unsubstituted polyisocyanates that are used to make the polyisocyanurate foam core 102 and other foam products include aromatic, aliphatic, and cycloaliphatic polyisocyanates having at least two isocyanate functional groups. Exemplary aromatic polyfunctional isocyanates include: 4,4′-diphenylmethane diisocyanate (MDI), polymeric MDI (PMDI), toluene disisocyanate, and allophanate modified isocyanate. For example, the polyfunctional isocyanate may be PMDI with functionality between 2.3 to 3.0, viscosity less at 800 cps at 25° C., and isocyanate content between 28% to 35%.

The polyfunctional isocyanates may be reacted with a polyfunctional co-reactant that has at least two reactive groups that react with the polyfunctional isocyanate to produce a polyisocyanurate compounds for the present products. Exemplary polyfunctional co-reactants may include polyester and polyether polyols having at least 2 isocyanate reactive groups, such as hydroxyl groups. Specific examples include aromatic polyester polyols which have good mechanical properties, as well as hydrolytic and thermo-oxidative stability. Commercially available polyester polyol include those sold by Stepan Company under the name Stepanol® and those sold by Huntsman Corporation under the name of Terol®. Exemplary polyols may have a functionality between 2 and 2.5 and hydroxyl number between 150 mg KOH/gm and 450 mg KOH/gm.

The catalysts used to polymerize the polyisocyanurates may include amine catalysts and metal catalysts, among other catalysts. The amine catalysts catalyze both urethane reactions between isocyanates and polyols, and urea reactions between water and isocyanates. The metal catalysts may include metal carbon/late trimer catalysts, which promote the conversion of isocyanate to highly thermally stable isocyanurate ring. Examples of suitable amine catalysts include pentamethyldiethylenetriamine (PMDETA), dimethylcyclohexylamine, and 1,3,5-tris(3-(dimethylamino)propyl)-hexahydro-triazine. Examples of suitable metal catalysts include potassium octoate and potassium acetate.

The present polyisocyanurate formulations may also include one or more surfactants. The surfactants function to improve compatibility of the formulation components and stabilize the cell structure during foaming. Exemplary surfactants can include organic or silicone based materials. Typical silicone based surfactants may include polyether modified polysiloxane, such as commercially available DC193 surfactant from AirProducts, and Tergostab® series surfactants from Evonik, such as Tergostab® 8535.

The polyol typically includes either or both a polyether and polyester having a hydroxyl number between about 25 and 500, and more commonly between about 200 and 270. The hydroxyl number is a measure of the concentration of the hydroxyl group in the polyol, which is expressed as the milligrams of KOH (potassium hydroxide) equivalent to the hydroxyl groups in one gram of polyol. Polyether is commonly not used in conventional polyisocyanurate foam boards because it is typically less flame resistant than the aromatic polyester that is used in such boards. A lower hydroxyl number commonly results in longer polymer chains and/or less cross linking, which results in a relatively loose polymer chain. In contrast, a higher hydroxyl number commonly results in more cross linking and/or shorter polymer chains, which may provide enhanced mechanical properties and/or flame resistance.

An isocyanurate is a trimeric reaction product of three isocyanates forming a six-membered ring. The ratio of the equivalence of NCO groups (provided by the isocyanate-containing compound or A-side) to isocyanate-reactive groups (provided by the isocyanate-containing compound or B side) may be referred to as the index or ISO index. When the NCO equivalence to the isocyanate-reactive group equivalence is equal, then the index is 1.00, which is referred to as an index of 100, and the mixture is said to be stoichiometrically equal. As the ratio of NCO equivalence to isocyanate-reactive groups equivalence increases, the index increases. Above an index of about 150, the material is generally known as a polyisocyanurate foam, even though there are still many polyurethane linkages that may not be trimerized. When the index is below about 150, the foam is generally known as a polyurethane foam even though there may be some isocyanurate linkages.

The polyisocyanurate core 102 has an isocyanate index greater than about 200, commonly between about 200 and 300, and more commonly between about 250 and 270. When isocyanate reacts with one or more polyols to form polyurethane, one NCO group reacts with one OH group. As is known in the art, the index is defined as the ratio of NCO group to OH group multiplied by 100 as shown in the formula below:

$$Index = \frac{Moles of NCO group}{Moles of OH group} X 100$$

When the number of NCO group equals the number of OH group in a formulation, a stoichiometric NCO:OH ratio of 1.0 is realized and a polyurethane polymer/foam is produced. When the number of NCO groups is significantly more than the number of OH groups in a formulation, the excess isocyanate group reacts with itself under catalytic condition to form isocyanurate linkage and polyisocyanurate foam is produced. The above described isocyanate index, and especially an index of between about 250 and 270, provides at least a 2:1 ratio of NCO groups to OH groups, which has been found to provide an appreciable combination of structure integrity, thermal strength and/or stability, and fire resistance. In some embodiments, the isocyanate index may be between 250-300.

In some embodiments, the polyisocyanurate core 102 may include between 1 and 10 weight percent of a hydrocarbon blowing agent, such as n-pentane, iso-pentane, cyclopentane, and their blends. In an exemplary embodiment, the polyisocyanurate core 102 may include between 5 and 8 weight percent of the hydrocarbon blowing agent. The weight percent of the hydrocarbon blowing agent typically corresponds with the foam density of the polyisocyanurate core 102 with lower density foam boards (e.g., insulation boards) having a higher weight percentage of the hydrocarbon blowing agent than more dense foam boards (e.g., roofing cover boards). For example, insulation boards having a density of between about 1.5 and 2.5 pounds per cubic foot (lbs/ft³), commonly have 5% or more of a hydrocarbon blowing agent by weight, and more commonly between about 6 and 7 weight percent. In contrast, roofing cover boards that have a density of up to 10 lbs/ft³, and more commonly between 6 and 7 lbs/ft³, commonly have less than 5% of a hydrocarbon blowing agent by weight, and more commonly between about 1.5 and 3 weight percent.

In some embodiments, the foam core 102 may include other substances. As illustrated below, Table 1 details the substances that form part of the foam core 102 and their ranges in percent by weight of the overall foam core 102.

TABLE 1

| Substance | Min. Percent by Weight | Max. Percent by Weight |
|---|---|---|
| Polyol | 5% | 45% |
| Viscosity Modifier | 0% | 10% |
| Surfactant | 0% | 2% |
| Amine Catalyst | 0% | 0.5% |
| Potassium Octoate | 0% | 2% |
| Potassium Acetate | 0% | 0.5% |
| Filler(s) | 0% | 50% |
| Water | 0% | 0.5% |
| Pentane | 1% | 4% |
| Isocyanate | 25% | 75% |

Foam board 100 also includes a first facer material 108 and a second facer material 110 that are applied to opposing outer major surfaces 106 of the polyisocyanurate core 102. The facer material 104 typically includes a glass fiber mat, but may include other types of facer materials. The facer materials 108, 110 are typically selected based on the type of polyisocyanurate foam board produced. Oftentimes, the facer materials 108, 110 include a coated glass fiber mat, a coated polymer bonded glass fiber mat, and the like. One or both of the facer materials 108, 110 may be coated on both sides of the facer 108, 110 or only on an exterior-facing side of the facer materials 108, 110. In such embodiments, the facers 108, 110 may include a mineral and/or pigment based coating with high solid content to provide one or more desired characteristics, such as low porosity, fire retardancy, mechanical strength, and the like. The facers 108, 110 may have a thickness of between about 0.3 and 1.2 mm.

The facers 108, 110 may be substantially coextensive with, coextensive with, or extend beyond the major surface of the foam core 102 to which each facers 108, 110 is bonded along the length(s) of any one, two, or three edges of the foam core 102 or along the lengths of all four edges of the foam core to overlap and be bonded to other roofing cover board composites. Facers 108, 110 may include a metal foil facer that is configured to reflect heat, such as from and/or into a structure, and/or may include an uncoated polymer bonded glass mat, coated polymer bonded glass mat, and the like. In such embodiments, the facers 108, 110 may have a thickness of between about 0.006 and 1.2 mm. The thickness of 0.006 mm typically represents the thickness of a metal facer while the 1.2 mm represents the thickness of other facers. The facers 108, 110 may be similar or different, may have a different thickness, and/or may have a different material coating as desired.

The polyisocyanurate foam board 100 may have an initial R-value of at least between about 4 and 7 per inch, with R-values of between about 5.5 and 6.55 being most common. For example, for a % inch thick foam board 100, the R-value may be between about 2 and 3.5, with R-values of 2.25 and 2.9 being most common.

PIR foam board 100 may also include an intumescent coating 112 applied to an exterior surface of at least one of the facers 108, 110. In some embodiments, the intumescent coating 112 may be an intumescent paint having a relatively low viscosity, while in other embodiments an intumescent paste or putty may be used having a relatively high viscosity. The intumescent coating 112 may be sprayed, dripped, painted, scraped, and/or otherwise applied to the exterior surface of facer 108, 110. The intumescent coating 112 may be applied to the facer 108, 110 at a coating weight of between about 5 and 50 g/sf, with coating weights of 40-48 g/sf being common for pastes and coating weights of between about 5-15 g/sf being common for paints. In some embodiments, the coating weight may be based at least in part of a viscosity of the intumescent coating 112. In some embodiments, rather than or in addition to being applied to an exterior surface of facer 108, 110, the intumescent coating 112 may be mixed into the mineral-based coating of the facer 108, 110 prior to or during application of the mineral-based coating during the formation process of the facer 108, 110.

The intumescent coating 112 chars and/or swell when exposed to flame and/or heat and also forms a high surface area insulating layer. In some embodiments, the intumescent coating 112 may include an acid source, a carbon source, and a spumific or gas source, although other formulations of intumescent coatings 112 may be utilized in some embodiments. In some embodiments, the acid include ammonium polyphosphate, melamine phosphate, magnesium sulphate, and/or boric acid. In some embodiments, the carbon source may include polyhydric alcohols such as pentaerythritol and dipentaerythritol, starch, and/or expandable graphite. Suitable gas sources include melamine, melamine phosphate, melamine borate, melamine formaldehyde, melamine cyanurate, tris-(hydroxyethyl) isocyanurate (THEIC), ammonium polyphosphate, and/or chlorinated paraffin.

In some embodiments, inorganic “nucleating” agents may be included to promote sites for the intumescent char to form and to improve the thermal resistance properties and stability of the intumescent char during a fire. Possible nucleating agents include titanium dioxide, zinc oxide, aluminum oxide, aluminum hydroxide, a polyamine polymer, limestone, attapulgite, perlite, silica, silicates, talc, kaolin, heavy metal oxides such as cerium oxide, lanthanum oxide, zirconium oxide, mica, and/or bentonite clay. It will be appreciated that fillers and/or other additives may also be included in the intumescent coating 112.

In a particular embodiment, the intumescent coating 112, when applied, may include ammonium polyphosphate in an amount of between about 25-45% by weight of intumescent ingredients (i.e. acid, carbon, gas, and/or nucleating agents; not including water or other additives), between abut 5-12% titanium dioxide, between about 3-15% melamine, and between about 3-15% pentaerythritol. In such embodiments, the intumescent coating 112 may have a pH of between about 7 and 8 and a specific gravity of between about 1.15 and 1.35.

In another embodiment, the intumescent coating 112 may include between about 15-35% by weight intumescent ingredients ammonium polyphosphate, between about 7-13% titanium dioxide, about 7-13% pentaerythritol, about 7-13% melamine, between about 7-13% glass wool fibers, between about 3-7% aluminum trihydroxide, and between about 1-5% ethylene glycol and/or butyl ether. The intumescent coating 112 may have a pH of between about 7.5-9.9 and a specific gravity of between about 1.4-1.8, with a viscosity of between about 20,000-40,000 centipoise.

In other embodiment, the intumescent coating 112 may include limestone in an amount of at least about 30% (more commonly between about 35% and 45% or between about 65% and 75%) by weight intumescent ingredients, less than 8% (oftentimes between about 1 and 5%) perlite, less than 8% (oftentimes between about 1 and 5% and more often less than 3%) talc, less than 8% (oftentimes between about 1 and 5%) attapulgite, less than 8% (oftentimes between about 1 and 5%) mica, and between about 1 and 5% (oftentimes less than about 2%) crystalline silica (quartz). In some embodiments, the intumescent coating 112 may also include other substances such as kaolin (in an amount of less than about 2%) and/or an acid and/or gas (which may be present in an amount of between about 15-45%. The intumescent coating 112 may have a pH of between about 7 and 9 and a specific gravity of between about 1.1 and 1.5, with a viscosity of between about 20,000-40,000 centipoise.

In various embodiments, the intumescent coating 112 typically include acid in an amount of about 15-45% by weight of intumescent ingredients, about 3-20% carbon source, and about 3-15% gas source. In some embodiments, the acid and the gas source may be the same substance and the total weight of the substance may be between about 3-30% by weight of the intumescent ingredients. Nucleating agents, when present, typically make up between about 1-30% by weight of the intumescent ingredients, although embodiments that are predominantly (greater than 80%) or entirely made up of nucleating agents are possible. The pH is typically between about 7 and 10 and the specific gravity of the intumescent coating 112 is typically between about 1.1 and 1.9.

FIG. 2 depicts a PIR foam board 200. PIR foam board 200 may be similar to foam board 100, but may have a facer material 208 coupled to only a single outer portion 206 of the foam core 202. An intumescent coating 212 similar to intumescent coating 112 is applied to an exterior surface of facer material 208. Foam core 202 may be formed of a polyol and an isocyanate as described in relation to FIG. 1. Here, the medial portion 204 may extend all the way to the edge of the foam core 202 opposite the facer 208. The medial portion 204 may include between about 75-90% of the thickness of the foam core 202.

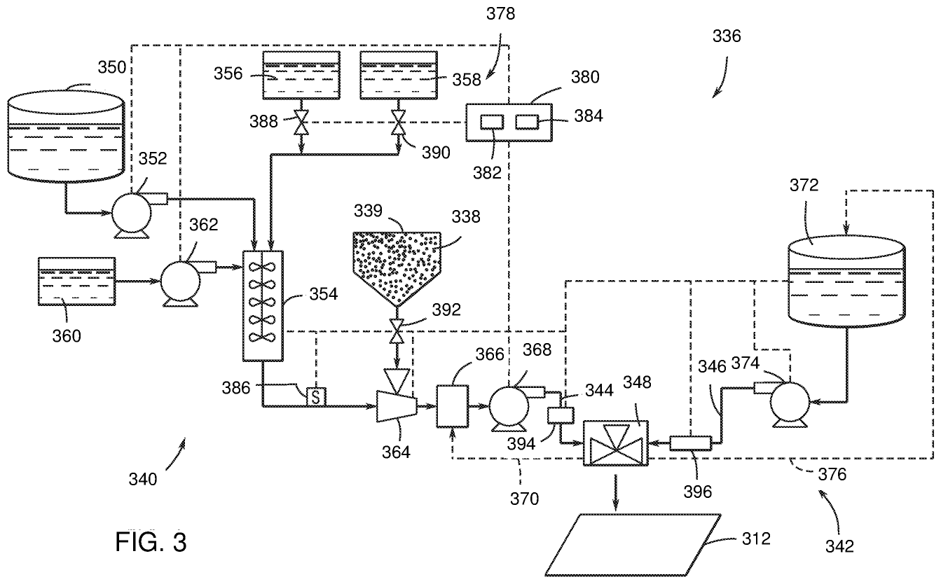

FIG. 3 is a schematic view of an embodiment of a PIR foam manufacturing system 336 that makes a PIR foam 312, such as that used to make foam core 102. As will be explained below, the manufacturing system 336 may include a first chemical line 340 and a second chemical line 342. The first chemical line 340 forms a first mixture 344 and the second chemical line 342 forms and/or carries a second chemical mixture 346 to a mixing head 348. At the mixing head 348, the manufacturing system 336 combines the first and second chemical mixtures 344, 346, enabling the first and second mixtures 344, 346 to chemically react and form the foam layer 312. For example, the first chemical line 340 includes an isocyanate-reactive compound such as a polyol. In accordance with the present invention, a threshold amount of water is included within the first chemical line 340. The order in which ingredients are added to the first chemical line 340 can be varied. The timing of the addition of the water can also be varied. For example, in some embodiments, water is combined with the polyol, optionally with one or more other ingredients such as surfactants, catalysts, and/or additives.

In some embodiments, water is introduced to the first chemical line 340 by using an in-line continuous mixer at a pressure of less than 3,400 kPa. In other embodiments, the water and the polyol are mixed at pressure of a less than 3,400 kPa to dissolve or emulsify the polyol and water within the B-side stream. In some embodiments, the water is introduced to the first chemical line 340 (i.e., combined with the polyol) prior to introducing the blowing agent.

The first chemical line 340 forms the first mixture 344, by pumping polyol 350 from a storage tank or polyol source 351 with a pump 352 into a mixer 354 (e.g., dynamic mixer). In the mixer the polyol 350 may be combined with one or more catalysts 356 (e.g., potassium octoate, potassium acetate, amine, surfactants, etc.) from a catalyst source 357. In some embodiments, additives and/or fillers may be added. For example, the polyol may be combined with a reactive viscosity additive 358 (e.g., propylene glycol, diethylene glycol, polypropylene glycol, propylene carbonate) from a viscosity additive source 359 that reduces the viscosity of the first mixture 344. In some embodiments, a filler 338 may be added to the first mixture 344 to increase the viscosity. By including the viscosity additive 358 the manufacturing system 336 is able to maintain a desired viscosity of the first mixture 344 with the added filler 338. The use of fillers (and resultant use of viscosity reduction additives) may be useful to further reduce the costs of producing the PIR foam boards, while maintaining sufficient material to produce a high density foam core 102. The fillers may include inorganic, organic powders, platelets, fibers, granules, or a combination thereof with particle sizes less than one hundred and fifty microns. In some embodiments, the particle size may be less than ten microns, which may facilitate mixing of the filler in the foam layer(s) 312 as well as homogeneity. Examples of fillers may include talc, kaolin, glass dust, mica, carbon black, magnesium hydroxide, gypsum, calcium carbonate, expanded perlite, glass fibers, or a combination thereof. In some embodiments, the viscosity additive 358 (e.g., propylene glycol, diethylene glycol, polypropylene glycol, etc.) may be selected to increase adhesion between the foam core 102 and any additional layers (e.g., facer materials 108, 110). In other words, the viscosity additive 358 may compensate for a possible reduction in adhesion between the foam core 102 and additional layers (e.g., facer materials 108, 110) when filler 338 is added to the foam core 102.

As the polyol 350, catalysts 356, and any optional viscosity additive 358 and/or filler 338 mix in the mixer 354, a blowing agent 360 (such as an alkane blowing agent like a pentane) from a blowing agent source 361 may be pumped into the mixer 354 with a pump 362. For example, the blowing agent 360 may be water mixed with pentane. During the chemical reaction between the first mixture 344 and the second mixture 346 the blowing agent 360 evaporates forming bubbles in the foam layer 312, which increases the insulative properties of the foam layer 312.

In some embodiments, the amount of alkane blowing agent (e.g., pentanes) used in the manufacture of polyisocyanurate foam is between about 12 and 40 parts by weight alkane blowing agent per 100 parts by weight of polyol, more commonly between about 18 and 33 parts by weight alkane blowing agent per 100 parts by weight of polyol.

Optionally, after exiting the mixer 354, the polyol 350, catalysts 356, any additives and/or blowing agent 360 enter a mixer 364 (e.g., solid-liquid mixer, eductor mixer) where filler 338 is added. As the filler 338 combines with the polyol 350, catalysts 356, viscosity additive 358, and blowing agent 360, the filler 338 increases the viscosity of the first mixture 344, which compensates for the previously added viscosity additive 358. In some embodiments, the filler 338 may be talc, kaolin, glass dust, mica, carbon black, magnesium hydroxide, gypsum, calcium carbonate, expanded perlite, glass fibers, or a combination thereof.

The first mixture 344 may then enter a tank 366 (e.g., a surge tank) that compensates for variations in the production process. For example, the manufacturing system 336 may include a return line 370 that redirects excess amounts of the first mixture 344 from the mixing head 348 to the tank 366 (e.g., during shutdown of the manufacturing system 336). From the tank 366, the first mixture 344 is pumped with a pump 368 to the mixing head 348. As the pump 368 pumps the first mixture 344 into the mixing head 348, the second chemical line 342 pumps a second mixture 346 (e.g., isocyanate 373) into the mixing head 348 using the pump 374. The first and second mixtures 344, 346 are then combined and discharged from the mixing head 348 to form the foam layer 312. In some embodiments, mixing head 348 is an impingement mix head. In particular embodiments, mixing takes place at a temperature of from about 5 to about 45° C. In some embodiments, mixing takes place at a pressure in excess of 2,000 psi. As explained above, when the first and second mixtures 344 and 346 combine they chemically react to form the foam 312 (e.g., polyurethane, polyisocyanurate, and one or more fillers). The mixture can then be deposited onto one or more facers 108, 110 or other layers to form an insulation board 100. For example, facer 108 may be positioned on a conveyor belt or other structure. The foam 312 may be poured onto the exposed upper surface of the facer 108. This allows a portion of the foam 312 to seep and penetrates into pores of the facer 108. A second facer 110 may be positioned atop the foam 312 to sandwich the foam 312 between the two facers 108, 110.

The board 100 may be positioned within and carried by a laminator. In some embodiments, the second facer 110 may be applied to the foam 312 prior to entering the laminator, while in other embodiments the second facer 110 may be applied while the first facer 108 and foam 312 are in the laminator. While in the laminator, foam 312 can be married to the facers 108, 110 to form a composite, which may also be referred to as a laminate. In some embodiments, the composite, while in laminator, or after removal from laminator, is exposed to heat that may be supplied by, for example, oven. For example, laminator may include an oven or hot air source that heats the slats and side plates of the laminator and there through transfers heat to the laminate (i.e., to the reaction mixture). Once subjected to this heat, the composite (i.e., the reaction mixture), or a portion of the composite (i.e., reaction mixture) can be allowed to cool and/or may undergo conventional finishing within a finishing station, which may include, but is not limited to, trimming and cutting. In some embodiments, the finishing may include tapering one or more edges of the board 100. For example, one or more edges of the board 100 may be compressed to form a tapered edge that makes taping, seaming, and patching easier during the installation process and provides a flatter finished product. In some embodiments, the tapering of any edges may be performed at the installation site, rather than during manufacturing. For example, a compression tool may be used to squeeze and taper the edges to a desired degree. Some or all of the edges of the board 100 may be compressed to up to 75% of the original thickness of the board 100. In some embodiments, the tapered edge(s) may be formed during the lamination process. For example, the laminator may be shimmed such that as the board 100 is formed, one or more edges are not allowed to expand to the full thickness, resulting in compressed and tapered edges.

After the foam board 100 has cured, the faced board 100 may be coated with an intumescent coating (such as intumescent coating 112) on one or more sides. For example, an intumescent coating may be painted, troweled, rolled, dripped, sprayed, and/or otherwise applied to exposed sides of the facer 108 and/or facer 110. In some embodiments, the intumescent coating may be applied to the board 100 in a continuous and/or uniform manner having a consistent coating weight across at least a substantial portion of the surface area of the board 100. In other embodiments, the intumescent coating may be applied to the board 100 so as to form a non-continuous and/or non-uniform layer, film, or coating atop the surface of the board 100. For example, the intumescent coating may be applied to the surface of the board 100 in a patterned arrangement (e.g., S-pattern, parallel or crossing lines, honeycomb pattern, dot pattern, splat pattern, and the like). In some embodiments, the intumescent coating may be applied to a board 100 with a coating weight of between 5-50 grams per square foot. The intumescent coating may be applied at a manufacturing facility and/or may be applied just prior to or during an installation process. For example, an uncoated board 100 may be shipped to a construction site and a builder may coat the board 100 with the intumescent coating prior to hanging on wall studs and/or after the board 100 has been hung. In some embodiments, an inorganic textile wallcovering may be applied to the coated board 100, either during manufacture or as part of an installation process.

It will be appreciated that while discussed with the additives, blowing agents, and/or fillers being present in the first stream (with the polyol), in some embodiments, one or more of the additional components may be included in the second stream. Additionally, it will be noted that the presence and/or quantities of any additives, fillers, and the like may be based upon the intended application of the final foam board product. In some embodiments, the manufacturing system 336 may include a return line 376 that returns excess second mixture 346 to the storage tank or isocyanate source 372 (e.g., during shutdown).

In order to control the manufacturing system 336, the manufacturing system 336 may include a control system 378. The control system 378 includes a controller 380 with one or more processors 382 that execute instructions stored on one or more memories 384 to control various components (e.g., pumps, mixers, valves, etc.) that form part of the first and second chemical lines 340, 342 using feedback from sensors and/or flowmeters.

For example, the manufacturing system 336 may include one or sensors 386 that monitor the mixing of the polyol 350, catalysts 356, viscosity additive 358, and blowing agent 360 and/or whether the polyol 350, catalysts 356, viscosity additive 358, and blowing agent 360 are within threshold ratios. If the proportions of polyol 350 and/or blowing agent 360 are outside of a threshold range, the controller 380 executes instructions with the processor 382 to increase and/or decrease the flow of the blowing agent 360 and/or polyol 350 using the pumps 352 and 362. Likewise, if the amounts of the catalysts 356 and/or viscosity additive 358 are outside of a threshold range, the controller 380 may execute instructions to control valves 388 and/or 390 to increase and/or decrease the amount of catalysts 356 and/or viscosity additive 358 entering the mixer 354.

Based on the measured amounts of polyol 350, catalysts 356, viscosity additive 358, and blowing agent 360, the controller 380 may control the amount of filler 338 that enters the mixer 364. For example, the controller 380 may control a valve 392 to increase and decrease the amount of filler 338 that enters the mixer 364. In some embodiments, the control system 378 may include a level sensor that detects the percentages of liquid and filler in the first mixture 344 to ensure the desired ratio of polyol 350, catalysts 356, viscosity additive 358 to filler 338 in the first mixture 344.

In order to control the ratio of the first mixture 344 to the second mixture 346 in the mixing head 348, the control system 378 may include flow meters 394, 396. As illustrated, the flow meter 394 enables measurement of the first mixture 344 entering the mixing head 348 and the flow meter 396 enables measurement of the second mixture 346 entering the mixing head 348. In operation, the controller 380 communicates with the flow meters 394, 396 and controls the pumps 368 and 374 in response to measured flow rates to ensure that the ratio of the first and second mixtures 344, 346 mix in the mixing head 348 within threshold ratios. In some embodiments, the concentration of the isocyanate-containing compound to the isocyanate-reactive compounds (polyol) within the respective chemical lines 340, 342 is adjusted to provide the foam product with an ISO index of between about 200-300.

It will be appreciated that other foam forming systems may be used to produce the PIR foam used in the foam boards of the present application. For example, additional systems are disclosed in U.S. Patent Publication No. 2017/0321028, filed on May 9, 2016, the entire contents of which is hereby incorporated by reference.

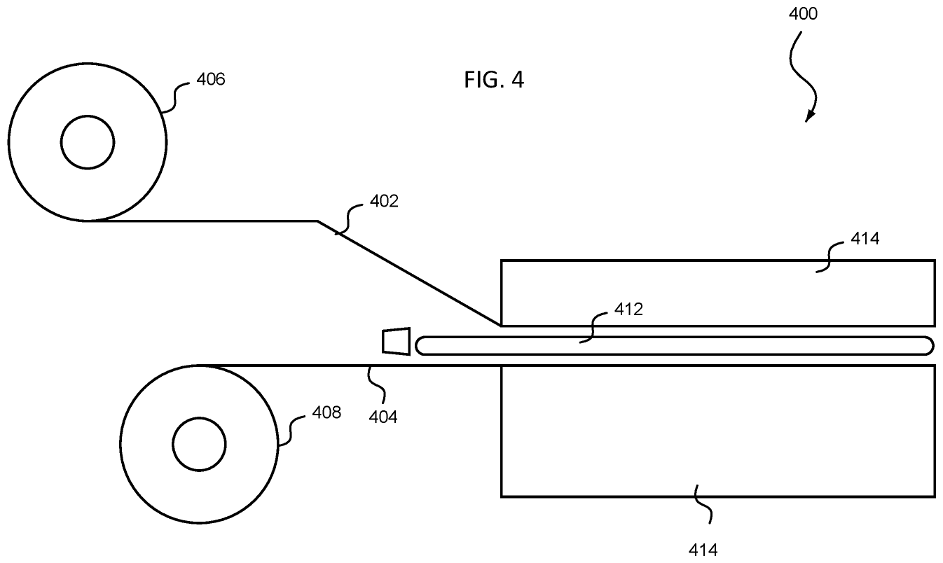

FIG. 4 depicts a schematic of a system 400 for producing PIR foam boards. System 400 may use the foam produced by system 300. Oftentimes, systems 300 and 400 are combined into a single assembly that not only produces the foam, but also uses the foam to produce foam boards, such as boards 100 and 200. System 400 includes a top facer material 402 and a bottom facer material 404. The facer materials 402, 404 may be unrolled from one or more facer rolls 406 and 408, respectively. As the facer materials 402, 404 are unrolled, a PIR foam 412, such as the foam 12 produced by system 400, may be applied to the facers 402, 404. For example, the foam 412 may be poured onto a bottom one of the facers 402, 404 and a top one of the facers 402, 404 may be positioned atop the foam such that the foam forms a foam core sandwiched between the two facers 402, 404.

Upon coupling the facers 402, 404 with the foam, the foam and facers 402, 404 may be inserted into a laminating device 414 that uses heat and/or pressure to adhere the layers together to form a foam insulation board. Once subjected to this lamination, the foam board can undergo conventional finishing within a finishing station, which may include, but is not limited to, trimming and cutting.

As discussed above, edges of the board may be tapered during and/or after the formation process. For example, edges of laminating device 414 may be shimmed to produce boards having tapered and/or compressed edges. The boards may also be coated with an intumescent coating, either at the factory and/or as part of an installation process.

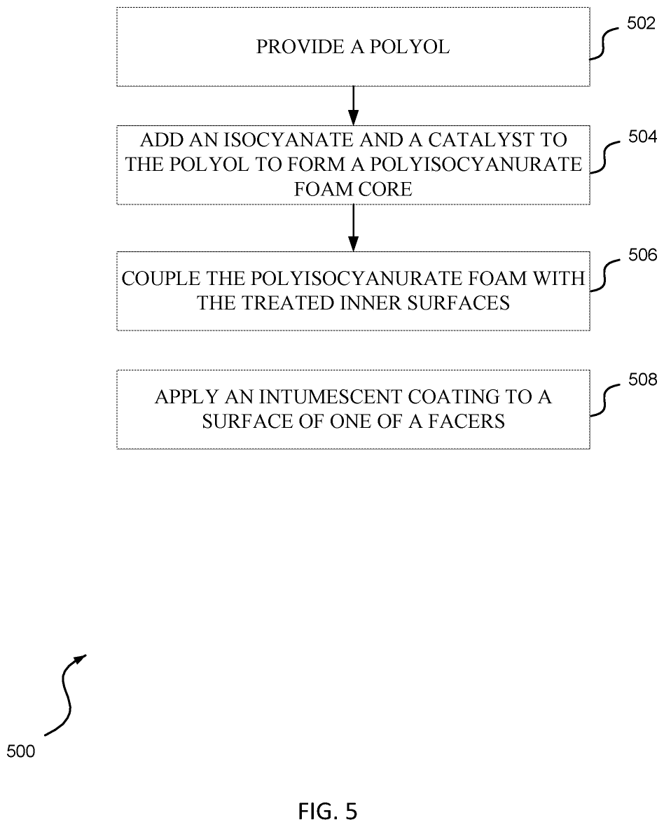

Referring now to FIG. 5, illustrated is a process 500 of forming a polyisocyanurate foam board. Process 500 may be used to form any of the foam boards described herein, and may involve the use of board fabrication systems such as those described in relation to FIGS. 3 and 4. At block 502, a polyol is provided. Suitable polyols include polyfunctional co-reactants that have at least two reactive groups that react with the polyfunctional isocyanate to produce a polyisocyanurate compounds for the present products. Exemplary polyfunctional co-reactants may include polyester and polyether polyols having at least 2 isocyanate reactive groups, such as hydroxyl groups. Specific examples include aromatic polyester polyols which have good mechanical properties, as well as hydrolytic and thermo-oxidative stability. Commercially available polyester polyol include those sold by Stepan Company under the name Stepanol® and those sold by Huntsman Corporation under the name of Terol®. Exemplary polyols may have a functionality between 2 and 2.5 and hydroxyl number between 150 mg KOH/gm and 450 mg KOH/gm.

At block 504, an isocyanate and a catalyst are added to the polyol to form a polyisocyanurate core having an isocyanate index greater than about 200. Suitable isocyanates may include polyfunctional isocyanates that may form substituted or unsubstituted polyisocyanates that are used to make the polyisocyanurate foam core 102 and other foam products include aromatic, aliphatic, and cycloaliphatic polyisocyanates having at least two isocyanate functional groups. Exemplary aromatic polyfunctional isocyanates include: 4,4′-diphenylmethane diisocyanate (MDI), polymeric MDI (PMDI), toluene disisocyanate, and allophanate modified isocyanate. For example, the polyfunctional isocyanate may be PMDI with functionality between 2.3 to 3.0, viscosity less at 800 cps at 25° C., and isocyanate content between 28% to 35%. At block 506, the polyisocyanurate foam is coupled to the surface of each facer material. In embodiments with two facers, the polyisocyanurate foam is sandwiched between the two facers such that the outer major surfaces of the foam partially penetrate into a body of the facers. In some embodiments, the process 500 may further include laminating the foam core to the facer(s) and/or cutting the foam board.

After the foam board is formed, an intumescent coating is applied to at least one surface of one of the facers at block 508. For example, an intumescent coating may be painted, rolled, troweled, sprayed, dripped, and/or otherwise applied to a major surface of one of the facers to provide greater flame resistant properties to the board. The intumescent coating may be applied as part of the manufacturing process and/or may be applied as part of an installation procedure for the foam board.

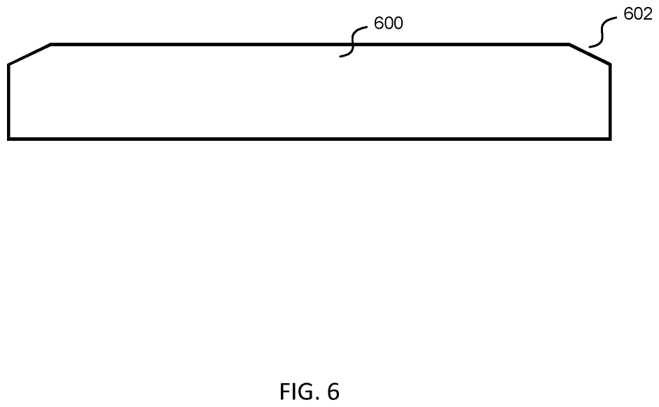

FIG. 6 illustrates a tapered edge of a polyiso foam board 600. Foam board 600 may be similar to foam boards 100 and 200. Here, an edge 602 of board 600 is tapered slightly to provide room for joint compound, fasteners, tape, and/or any other materials during an installation process. For example, two boards 600 may be positioned side by side with one another such that their respective tapered edges 602 abut one another, which provides an indented interface that can received fasteners, tape, joint compound, etc. The edge 602 may be compressed to up to 75% of the original thickness of the board 600. As noted above, the tapered edge 602 may be formed during a lamination process and/or after the board 600 is formed by applying compressive force to the edge 602. While only one edge 602 is shown in FIG. 6, it will be appreciated that any arrangement of edges of a board 600 may be tapered. Oftentimes two lateral edges 602 (such at the 8 ft edges 602 on a 4×8 ft board 600) may be tapered. In other embodiments two shorter edges 602 may be tapered, while in other embodiments all edges of the board 600 may be tapered.

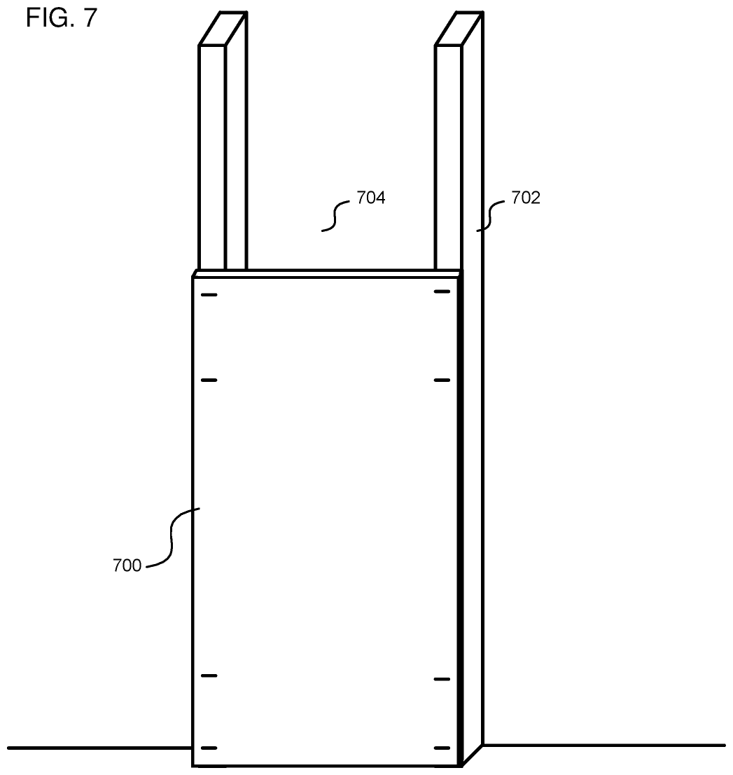

FIG. 7 illustrates a polyiso foam board 700 secured to wall studs 702 in an interior walling application. Board 700 may be similar to the boards 100, 200, and 600 described elsewhere herein. As shown, two or more wall studs 702 are provided that define a wall cavity 704 therebetween. Board 700 may be secured to the wall studs 702 such that the board 700 extends across and covers the wall cavity 704, with a side that is coated with the intumescent coating being exposed and pointing away from the wall cavity 704 and toward an interior of the room. The board 700 may be secured to the wall in any number of ways. For example, as shown here, board 700 is secured to the wall studs 702 using a number of crown staples that extend through the board 700 and into the wall studs 702. In other embodiments, screws, such as drywall screws and/or other fasteners may be used. In some embodiments, in addition to or instead of fasteners, the board 700 may be secured to the wall studs 702 using an adhesive applied to the interfaced formed where the wall studs 702 and board 700 meet. This is possible due to the lightweight nature of the board 700. In some embodiments, board 700 has one or more tapered edges (such as shown in FIG. 6) that allow adjacent boards 700 to be taped, seamed, and mudded while still providing a relatively flat finish. While not shown, it will be appreciated that similar hanging techniques may be utilized to secure the boards 700 in ceiling applications in which the boards 700 are attached to ceiling joists rather than wall studs.

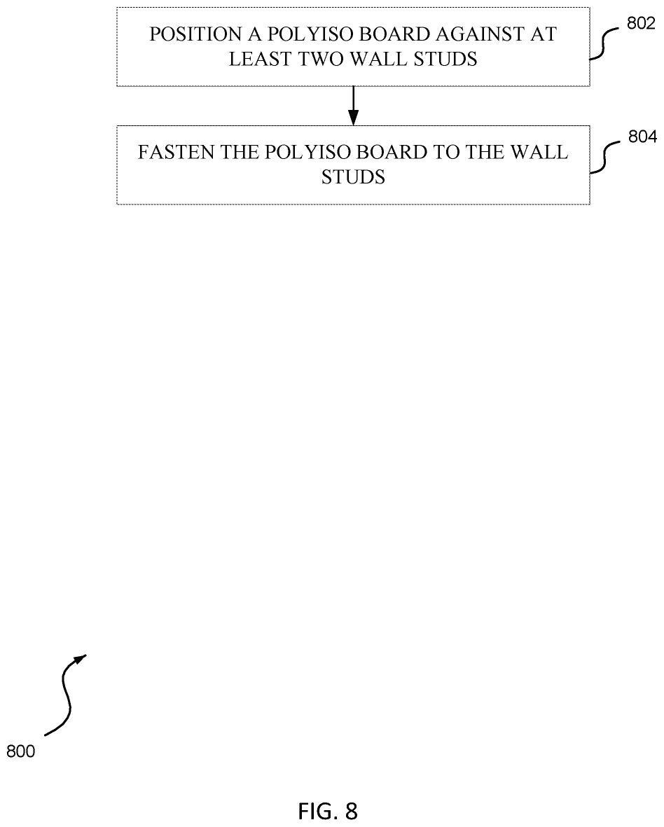

FIG. 8 is a flowchart illustrating a process 800 for installing a polyiso foam wall board in accordance with the present invention. Process 800 may involve the use of any of the foam boards described herein. Process 800 may begin at block 802 by positioning a polyiso foam wall board against at least two wall studs to cover at least a portion of a wall cavity formed therebetween. The polyiso foam board may include a polyisocyanurate foam core produced from an isocyanate and a polyol. The foam board may also include a facer material applied to an outer surface of the polyisocyanurate foam core, possibly on both sides of the foam core. The polyiso foam wall board may be fastened to the at least two wall studs at block 804. In some embodiments, this may include using a pneumatic (or other device) device to insert crown staples through the polysio foam wall board and into the at least two wall studs. In other embodiments, fastening the polyiso foam wall board to the wall studs involves applying an adhesive to an interface between the polyiso foam board and the at least two wall studs. Other fastening mechanisms, such as drywall screws, may also be used.

The foam boards also include an intumescent coating applied to an outer surface of the facer material. In some embodiments, this coating may be applied at a factory. In some embodiments, process 800 may include applying this coating to the exposed facer surface. For example, an installer may roll, spray, trowel, paint, and/or otherwise apply a layer of the coating onto the facer before or after fastening the board to the wall studs. In some embodiments, each wall board has at least one tapered edge that may be positioned against an adjacent board's tapered edge to provide a spacing for applying fasteners, tape, joint compound, and/or other materials to hang and join multiple pieces of foam board to form a wall (or ceiling) structure. Once hung, the boards can be mudded textured, painted, and/or otherwise finished in a manner similar to that used to finish gypsum drywall sheets.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

1. A polyiso foam wall board, comprising:
a polyisocyanurate foam core produced from:
an isocyanate; and
a polyol;
a facer material applied to an outer surface of the polyisocyanurate foam core; and
an intumescent coating applied to the facer material, wherein the intumescent coaling comprises limestone, perlite, and talc, wherein:
an amount of the limestone is at least about 30% by weight;
an amount of the perlite is less than about 8% by weight; and
an amount of the talc is less than about 8% by weight.

2. The polyiso foam wall board of claim 1, wherein:
the intumescent coating comprises one or more of ammonium polyphosphate, titanium dioxide, a melamine, pentaerythritol, kaolin, a polyamine polymer, tetraethylene pentamine, or aluminum tri hydroxide.

3. (canceled)

4. The polyiso foam wall board of claim 1, wherein:
the intumescent coating further comprises:
attapulgite and mica, wherein:
an amount of the attapulgite in the intumescent coating is less than about 8% by weight; and
an amount of the mica in the intumescent coating is less than about 8% by weight.

5. The polyiso foam wall board of claim 1, wherein:
the facer material comprises a nonwoven glass mat facer.

6. The polyiso foam wall board of claim 1, wherein:
the intumescent coating is applied with a coating weight of between about 5 and 50 g/sf.

7. The polyiso foam wall board of claim 1, wherein:
the polyiso foam wall board comprises at least one tapered edge.

8.-20. (canceled)

21. The polyiso foam wall board of claim 1, wherein:
the polyisocyanurate foam core has an insulative R-value between about 4 and 7 per inch at 40° F.

22. The polyiso foam wall board of claim 1, wherein:
the polyisocyanurate foam core has an isocyanate index greater than or equal to 250.

23. The polyiso foam wall board of claim 1, wherein:
the polyisocyanurate foam core comprises an average foam cell size of less than 200 microns.

24. The polyiso foam wall board of claim 1, wherein:
a density of the polyisocyanurate foam core is between about 1 and 10 lbs/ft³.

25. The polyiso foam wall board of claim 1, wherein:
a portion of the polyisocyanurate foam core penetrates fibers of the facer material.
